(19) United States
(12) Patent Application Publication
(10) Pub. No.: US 2001/0029582 A1
(43) Pub. Date: Oct. 11, 2001

(54) Method and system for copy protection of data content

(76) Inventors: Daniel Isaac Goodman, Beit Shemesh (IL); Daniel Schreiber, Beit Shemesh (IL)

Correspondence Address: FENWICK & WEST LLP, TWO PALO ALTO SQUARE, PALO ALTO, CA, 94306, US

(21) Appl. No.: 09/774,236

(22) Filed: Jan. 29, 2001

Related U.S. Application Data
(63) Continuation-in-part of application No. 09/397,331, filed on Sep. 14, 1999.
Application No. 09/397,331 is a continuation-in-part of application No. 09/313,067, filed on May 17, 1999, now Pat. No. 6,209,103.

(51) Int. Cl. H04L 9/32; G06F 11/30; G06F 12/14

(52) U.S. Cl. 713/193

(57) ABSTRACT

A method for protecting content within a page displayed by a Computer, including identifying a designated portion of original content contained within a page, to be protected, encrypting the designated portion of original content to form a portion of encrypted content, replacing the designated portion of original content within the page with the portion of encrypted content, rendering the page into a graphics device, including decrypting the portion of encrypted content, and displaying at least a portion of data from the graphics device. A system is also described and claimed.

### CROSS REFERENCES TO RELATED APPLICATIONS

This application is a continuation-in-part of assignee's pending application U.S. application Ser. No. 09/397,331, filed on Sep. 14,1999, entitled “Method and System for Copyright Protection of Digital Images Transmitted Over Networks.”

### FIELD OF THE INVENTION

The present invention relates to copy protection of data content, including content that is displayed by a computer on a display device.

### BACKGROUND OF THE INVENTION

Information in the form of text is commonly transmitted among computers in the way of files, such as Microsoft Word documents, Microsoft Excel spreadsheets, Microsoft PowerPoint slides, HTML web pages, XML documents and many other types of files that include text. Typically, a user viewing such files can freely copy portions of text included therewithin by several well-known means. For example, a user can select a portion of text with an input device such as a mouse or keyboard, copy the selected portion of text and paste it into another document, such as the body of an e-mail. For another example, a user can capture the contents of a screen by performing a screen capture, and insert the contents into another document.

Text within web pages is particularly susceptible to copying. Web browsers displaying HTML pages typically enable a user to view source files for HTML pages being displayed. For example, in the Microsoft Windows operating system running the Microsoft Internet Explorer or the Netscape Communicator web browsers, a user merely clicks on a right mouse button when the mouse is positioned over an HTML page, and selects “View Source.” The source file for the HTML page is then typically displayed in its entirety within a new window. A user can then readily select any portion of text from the source file, copy it and paste it into another document.

Some applications, such as Adobe's PDF Acrobat, can create non-editable files that can only be viewed within an application that can disable the ability to copy selections of text, such as Adobe's PDF Reader. However, a user can capture any portion of a PDF file displayed on a screen by performing a simple screen capture.

Many information services earn their revenues by providing information to clients. Examples of such services include financial services, marketing services, news services and legal services. Moreover, such information is often provided electronically. Using today's technology, a subscriber who receives such electronic information can easily copy it and e-mail it to his friends, thereby obviating the need for his friends to subscribe to the service and pay subscription fees.

There is thus a pressing need to find a way to prevent text that is displayed on a computer from being copied without authorization.

U.S. Pat. No. 5,905,505 of Lesk describes an image-based method and system for protecting text displayed on a screen. Lesk operates on a bit-mapped image of the text. Lesk creates two perturbed images, by adding random bits to the bit-mapped image of the text, and displays the two perturbed images rapidly in alternate succession. In this way, a user sees the desired image of the text by averaging both perturbed images, but at any given moment only one of the two perturbed images is displayed on the screen. Thus someone copying data from the screen only captures a perturbed image, which is difficult to decipher.

Lesk is difficult to implement in practice, since (1) the random bits have to be generated in such a way that the average of the two perturbed images appears “clean” and legible, whereas each of the individual perturbed images appears “dirty,” (2) Lesk has to be practiced at the level of a video frame buffer, (3) for Internet applications, Lesk has to be practiced for each portion of an HTML page being viewed, and (4) it may not be comfortable for a user to view a monitor that is constantly alternating displays. Moreover, it is possible to overcome Lesk by capturing two screens containing both perturbed images, and then averaging them together digitally.

There is thus a need to find a simpler and more practical way to prevent text displayed on a computer from being copied without authorization.

### SUMMARY OF THE INVENTION

The present invention provides a method and system for copy protection of content, including text within a document page, such as an HTML page, that is displayed by a computer on a display device. In a preferred embodiment, the present invention encrypts content designated as protected, and only decrypts the content when a page containing the content is being rendered into a graphics device for display. This serves to protect the designated content while it is off-screen. Specifically, when the present invention is employed to protect text content, an application viewing a source listing of the document page, or capturing the document page, is only able to capture encrypted text, which typically appears as gibberish.

To supplement the off-screen protection, the present invention preferably incorporates the invention described in assignee's pending application U.S. Ser. No. 09/397,331, filed on Sep. 14, 1999, entitled “Method and System for Copyright Protection of Digital Images Transmitted over Networks.” The invention described in U.S. Ser. No. 09/397,331 protects data while it is onscreen. Thus, the present invention, when combined with the invention described in U.S. Ser. No. 09/397,331 protects designated content both while it is on-screen and while it is off-screen.

In a preferred embodiment of the present invention, protected text in HTML pages or other documents is encrypted, and only decrypted when being rendered into a graphics device by system text rendering functions such as Microsoft Windows' TextOut( ) function or Macintosh's DrawText( ) function.

In a general context the present invention provides a methodology to protect content of data that is rendered and formatted using patchable system calls. The present invention applies not only to protection of text, but also to protection of image data, audio data, video data and other data content.

The present invention is useful for protection of content within HTML and e-mail and, more generally, for protection of enterprise data.

Although a user viewing content sees the protected content, at every other level of the system except for a frame buffer within a video card, the content is encrypted. In distinction to the present invention, conventional encryption technologies, such as PGP, decrypt encrypted content to a temporary file, from which a user views protected content. The present invention, however, does not decrypt encrypted content at the application level—only at the display level.

There is thus provided in accordance with a preferred embodiment of the present invention a method for protecting content within a page displayed by a computer, including identifying a designated portion of original content contained within a page, to be protected, encrypting the designated portion of original content to form a portion of encrypted content, replacing the designated portion of original content within the page with the portion of encrypted content, rendering the page into a graphics device, including decrypting the portion of encrypted content, and displaying at least a portion of data from the graphics device.

There is further provided in accordance with a preferred embodiment of the present invention a system for protecting content within a page displayed by a computer, including a parser identifying a designated portion of original content contained within a page, to be protected, an encoder encrypting the designated portion of original content to form a portion of encrypted content, an editor replacing the designated portion of original content within the page with the portion of encrypted content, a graphics device, a renderer rendering the page into the graphics device, including a content decoder decrypting the portion of encrypted content, and a display device displaying at least a portion of data from the graphics device.

There is yet further provided in accordance with a preferred embodiment of the present invention a method for protecting content contained within a page displayed by a computer, including accessing a page containing a portion of encrypted content, rendering the page into a graphics device, including decrypting the portion of encrypted content, and displaying at least a portion of data from the graphics device.

There is moreover provided in accordance with a preferred embodiment of the present invention a system for protecting content contained within a page displayed by a computer, including computer hardware storing a page containing a portion of encrypted content, a graphics device, a renderer rendering the page into the graphics device, including a decoder decrypting the portion of encrypted content, and a display device displaying at least a portion of data from the graphics device.

There is additionally provided in accordance with a preferred embodiment of the present invention a method for protecting content contained within a page displayed by a computer, including identifying a designated portion of original content within a page, to be protected, encrypting the designated portion of original content to form a portion of encrypted content, and replacing the designated portion of original content within the page with the portion of encrypted content.

There is further provided in accordance with a preferred embodiment of the present invention a system for protecting content contained within a page displayed by a computer, including a parser identifying a designated portion of original content within a page, to be protected, an encoder encrypting the designated portion of original content to form a portion of encrypted content, and an editor replacing the designated portion of content within the page with the portion of encrypted content.

There is yet further provided in accordance with a preferred embodiment of the present invention a method for protecting text within a page displayed by a computer, including identifying a portion of original text within a page that is to be rendered for viewing by a renderer, creating alternate text, and replacing the portion of original text within the page with the alternate text, wherein the layout of the alternate text within the page is perceived by the renderer to be substantially similar to the layout of the portion of original text within the page.

There is moreover provided in accordance with a preferred embodiment of the present invention a system for protecting text within a page displayed by a computer, including a parser identifying a portion of original text within a page that is to be rendered for viewing by a renderer, a text processor creating alternate text, and an editor replacing the portion of original text within the page with the alternate text, wherein the layout of the alternate text within the page is perceived by the renderer to be substantially similar to the layout of the portion of original text within the page.

There is additionally provided in accordance with a preferred embodiment of the present invention a method for protecting content within a page displayed by a computer, including encrypting a designated portion of original content contained within a page to form a portion of encrypted content, replacing the designated portion of original content within the page with the portion of encrypted content, and decrypting the portion of encrypted content when rendering the page into a graphics device.

There is further provided in accordance with a preferred embodiment of the present invention a system for protecting content within a page displayed by a computer, including an encoder encrypting a designated portion of original content contained within a page to form a portion of encrypted content, an editor replacing the designated portion of original content with the portion of encrypted content, within the page, and a content decoder decrypting the portion of encrypted content when rendering the page into a graphics device.

There is yet further provided in accordance with a preferred embodiment of the present invention a method for protecting content contained within a page displayed by a computer, including accessing a page containing a portion of encrypted content, and decrypting the portion of encrypted content when rendering the page into a graphics device.

There is moreover provided in accordance with a preferred embodiment of the present invention a system for protecting content contained within a page displayed by a computer, including computer hardware storing a page containing a portion of encrypted content, and a content decoder decrypting the portion of encrypted content when rendering the page into a graphics device.

There is additionally provided in accordance with a preferred embodiment of the present invention a method for protecting text within a page displayed by a computer, including replacing first text strings with second text strings when formatting a page to determine a page layout, and replacing a first portion of text with a second portion of text when rendering the page according to the page layout into a graphics device.

There is further provided in accordance with a preferred embodiment of the present invention a system for protecting text within a page displayed by a computer, including a string processor replacing first text strings with second text strings when formatting a page to determine a page layout, and a text processor replacing a first portion of text with a second portion of text when rendering the page according to the page layout into a graphics device.

### BRIEF DESCRIPTION OF THE DRAWINGS

The present invention will be more fully understood and appreciated from the following detailed description, taken in conjunction with the drawings in which:

FIG. 1A is an illustration of an HTML page with protected text being displayed by a web browser with the intervention of a decoder;

FIG. 1B is an illustration of an HTML page with protected text being viewed without the intervention of a decoder;

FIG. 1C is an illustration of a display of a source listing for the HTML page of FIG. 1A;

FIG. 1D is an illustration of a watermarked image resulting from an attempt to capture the page of FIG. 1A from a display screen; and

FIG. 2 is a simplified block diagram of a prior art system for delivering and rendering a page;

FIG. 3 is a simplified flow diagram of a prior art method for delivering and rendering a page;

FIG. 4 is a simplified block diagram of a system for protection of content within a page according to a preferred embodiment of the present invention;

FIG. 5 is a simplified flow diagram of a method for protection of content within a page according to a preferred embodiment of the present invention;

FIG. 6 is a simplified block diagram of a system for protection of content within a page including a formatting module, according to a preferred embodiment of the present invention; and

FIG. 7 is a simplified flow diagram of a method for protection of content within a page including a formatting step, according to a preferred embodiment of the present invention.

### DETAILED DESCRIPTION OF A PREFERRED EMBODIMENT

The present invention provides a method and system for copy protection of content, including text within a document page, such as an HTML page, that is displayed by a computer on a display device. In a preferred embodiment, the present invention encrypts content designated as protected, and only decrypts the content when a page containing the content is being rendered into a graphics device for display. This serves to protect the designated content while it is off-screen. Specifically, when the present invention is employed to protect text content, an application viewing a source listing of a document page, or capturing a document page, is only able to capture encrypted text, which typically appears as gibberish.

To supplement the off-screen protection, the present invention preferably incorporates the invention described in assignee's pending application U.S. Ser. No. 09/397,331, filed on Sep. 14,1999, entitled “Method and System for Copyright Protection of Digital Images Transmitted over Networks,” the contents of which are hereby incorporated by reference. The invention described in U.S. Ser. No. 09/397,331 protects data while it is on-screen. Thus, the present invention, when combined with the invention described in U.S. Ser. No. 09/397,331 protects designated content both while it is on-screen and while it is off-screen.

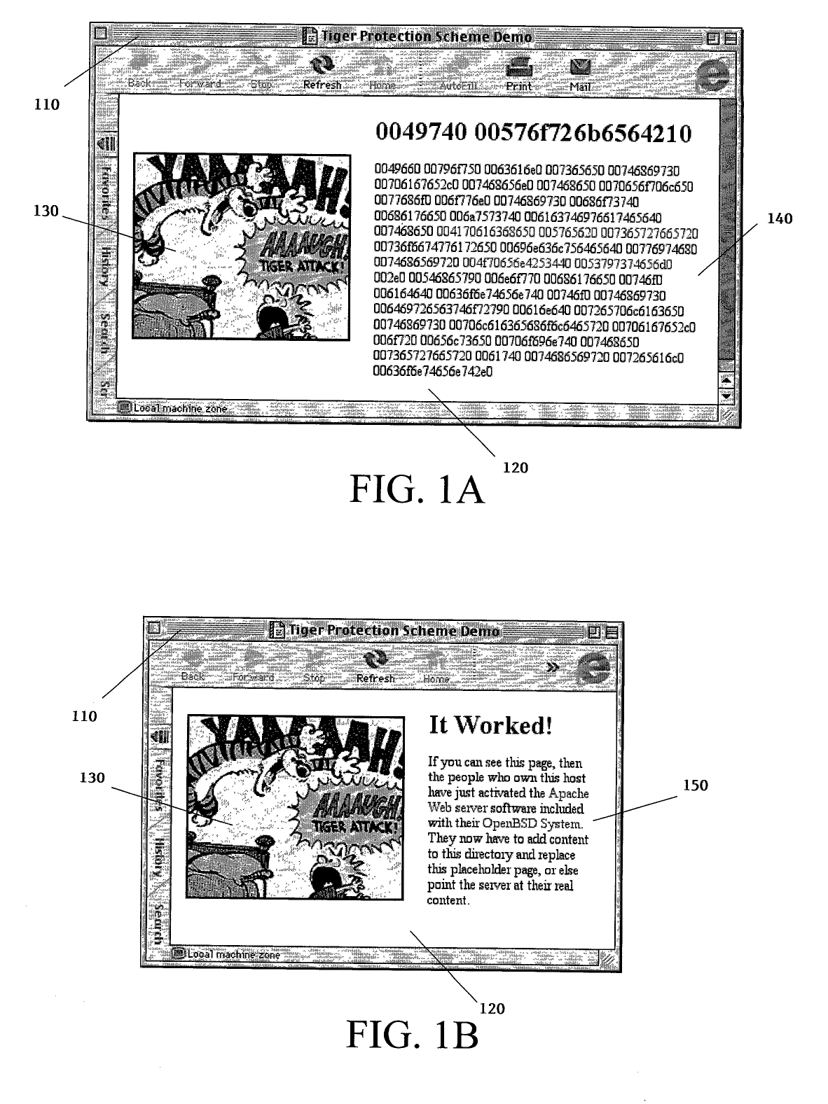

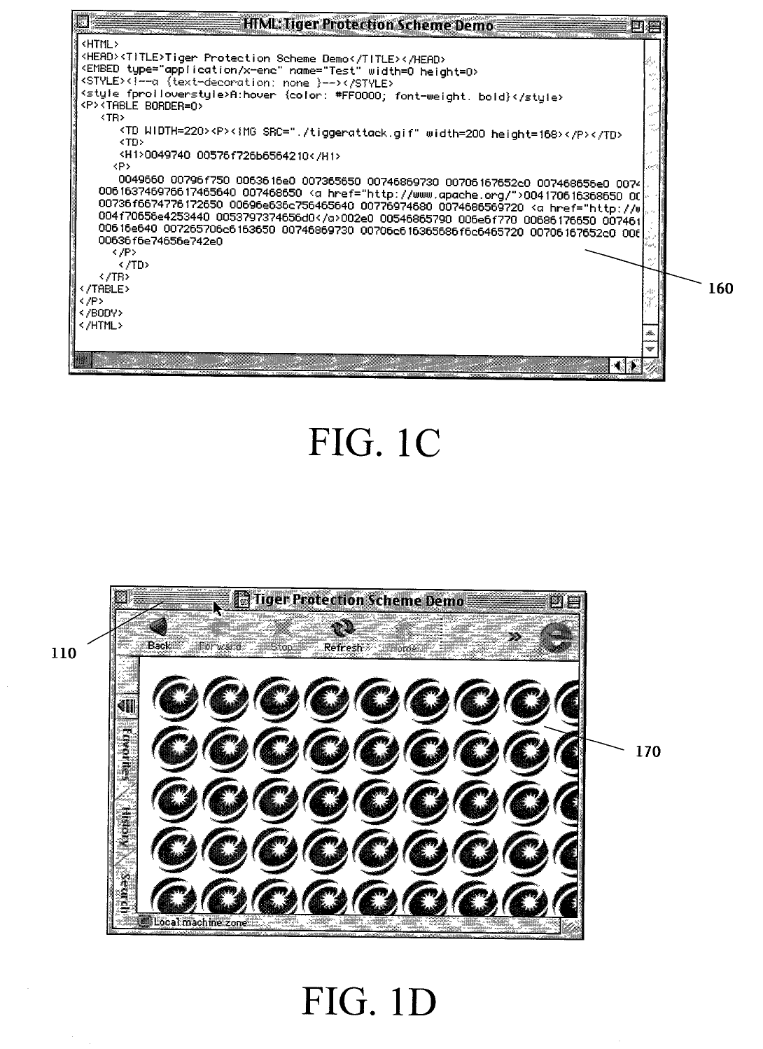

Reference is now made to FIG. 1A, which is an illustration of an HTML page with protected text, being viewed by a web browser without the intervention of a decoder. Shown in FIG. 1A is a window 110 displaying an HTML page 120 containing an image 130 in the left side of the page, and text 140 in the right side of the page. The protected text is encrypted to text 140, and without the intervention of a decoder, appears as gibberish on a display.

Reference is now made to FIG. 1B, which is an illustration of an HTML page with protected text, being viewed with the intervention of a decoder. In accordance with a preferred embodiment of the present invention, prior to converting encrypted text 140 (FIG. A) to a graphics output format, a decoder intercepts the encrypted text and decodes it to decrypted text 150. The viewer is thus able to display the original protected text, even though HTML page 120 contains only encrypted text.

Reference is now made to FIG. 1C, which is an illustration of a display of a source listing for HTML page 120 of FIG. 1B. Such a display can be obtained by a “View Page Source” command within a web browser. Since HTML page 120 contains encrypted text, when a user views the source for HTML page 120 it reveals only encrypted text 160—even though the display of the page shows decrypted text.

Reference is now made to FIG. 1D, which is an illustration of a watermarked image 170 resulting from an attempt to capture the page of FIG. 1B from a display screen. Using the invention described in the above referenced U.S. Ser. No. 09/397,331, when window 110 is captured, say, by invoking a screen capture command, the captured image is watermarked prior to being copied to a clipboard. When contents of the clipboard are subsequently pasted into an application, only watermarked image 170 appears. It can thus be appreciated that the present invention protects text from being copied while displayed on-screen, and also within an HTML page off-screen.

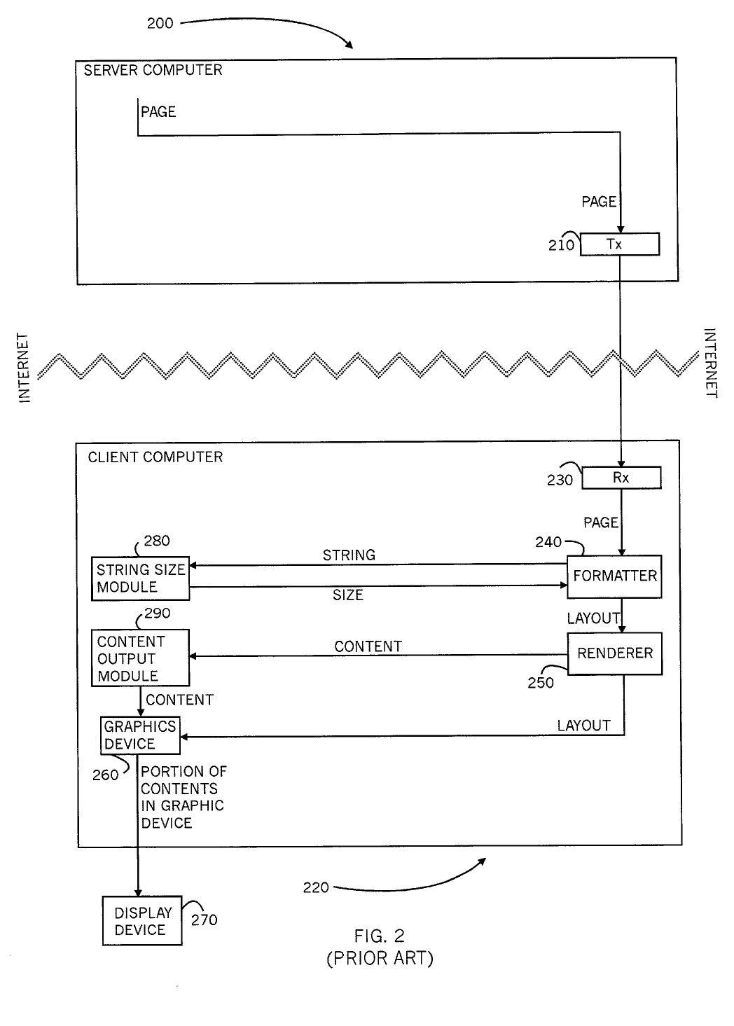

Reference is now made to FIG. 2, which is a simplified block diagram of a prior art system for delivering and rendering a page. A server computer 200 contains documents that include pages having original content therewithin. By way of example, pages may be Internet web pages such as HTML or XML pages, pages within a Microsoft Word document, pages within an Excel spreadsheet, or pages within a Microsoft PowerPoint presentation. A transmitter 210 transmits a page to a client computer 220 over the Internet.

Client computer 220 includes a receiver 230 that receives the page and transfers it to a formatter 240 for determining a page layout, as described hereinbelow. After formatter 240 determines a page layout, a renderer 250 renders the page into a graphics device 260. By way of example, renderer 250 may be a web browser, which renders HTML pages. Also, by way of example, graphics device 260 may be a memory device, a screen device or a graphics port. Within the Microsoft Windows operating system, Netscape Communicator renders HTML pages directly into a screen device, and Microsoft Internet Explorer renders HTML pages into a memory device. Within the Macintosh operating system, both Netscape Communicator and Microsoft Internet Explorer render HTML pages into a graphics port.

Finally, a portion of data in graphics device 260, or all of the data in graphics device 260, is displayed on a display device 270 connected to client computer 220.

The operation of formatter 240 will now be described. Formatter 240 determines a page layout for a given page. Typically, formatter 240 determines how many words to place within lines of the given page, based on the font type and font size currently selected. To determine widths of words, formatter 240 sends character strings to a string size module 280. String module 280 accepts a character string as input, and returns the width of the string, based on the font type and font size currently selected. Formatter 240 repeatedly sends individual words to string module 280, or strings with multiple words therein, in order to identify widths of text and thereby determine how many words to fit within lines of the page. Formatter 240 passes a page layout to renderer 250. String module 280 is typically an operating system function, such as the Microsoft Windows GetTextExtent( ) function.

The operation of renderer 250 will now be described. Renderer 250 sends content such as text to a content output module 290. Content output module accepts content as input and converts the content to graphics output, such as raster output or vector output, for writing to graphics device 260. Content output module 290 is typically one or more operating system functions, such as the Microsoft Windows TextOut( ) function and the Macintosh DrawText( ) function.

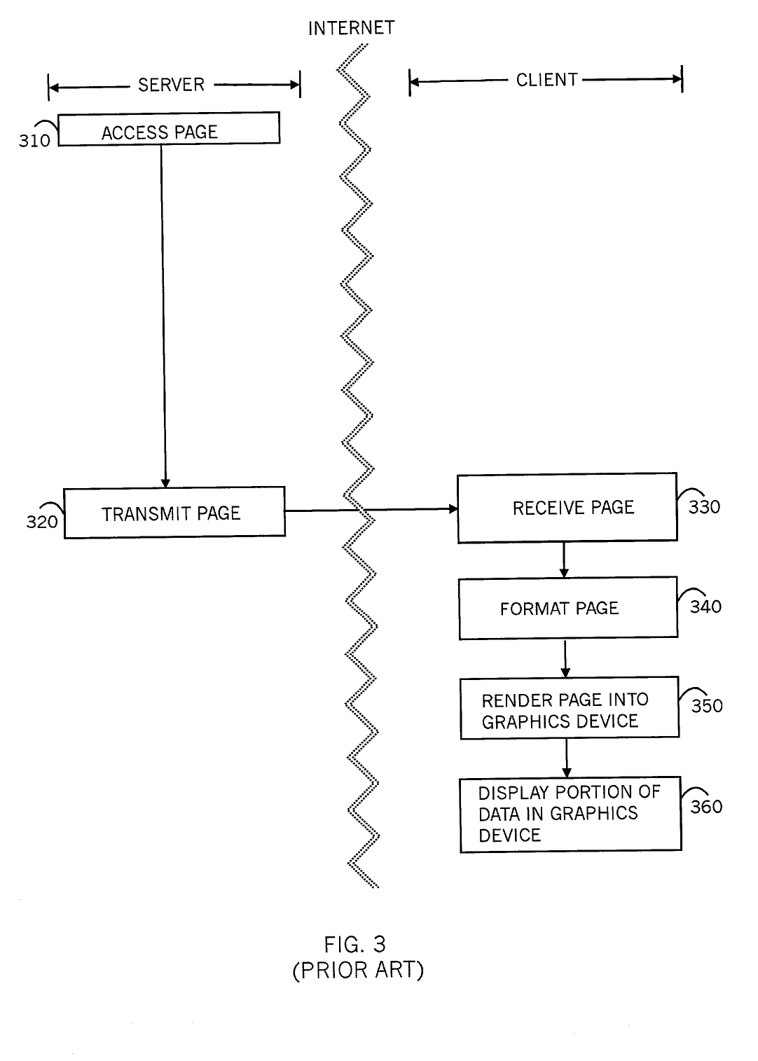

Reference is now made to FIG. 3, which is a simplified flow diagram of a prior art method for delivering and rendering a page. At step 310 a server computer, such as server computer 100 (FIG. 2) accesses a web page. At step 320 the server computer transmits the page to a client computer, such as client computer 220 (FIG. 2), over the Internet.

At step 330 the client computer receives the page. At step 340 the client computer formats the page to determine a page layout. At step 350 the client computer renders the page into a graphics device, based on the page layout. At step 360 the client computer displays a portion or all of the contents in the buffer on a display device connected to the client computer.

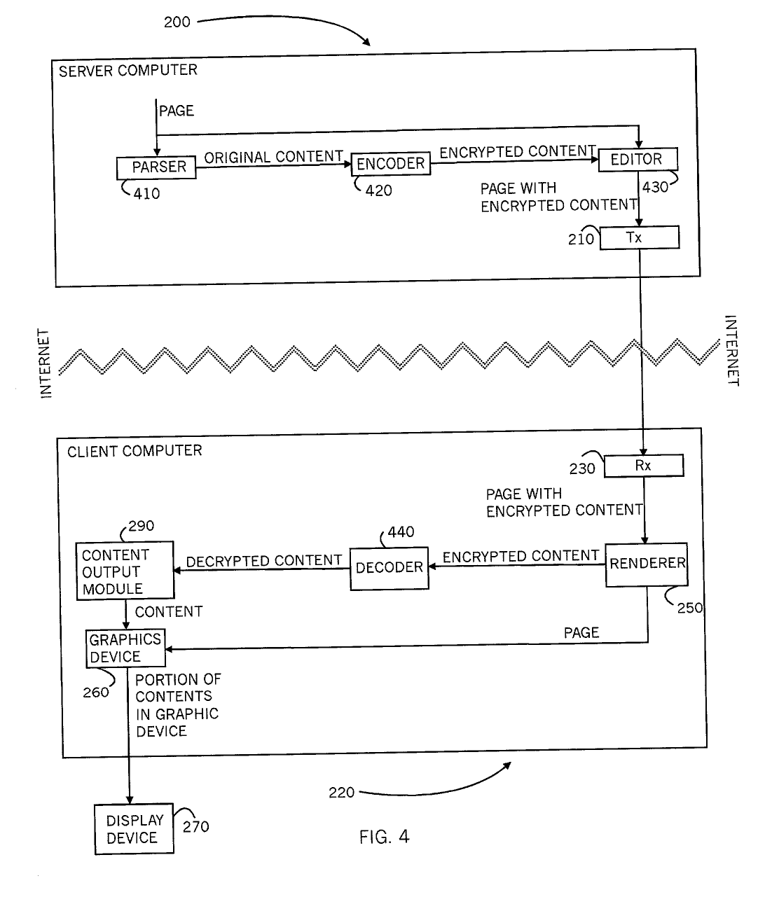

Reference is now made to FIG. 4, which a simplified block diagram of a system for protection of content within a page according to a preferred embodiment of the present invention. Server computer 200 contains documents that include pages having original content therewithin. In a preferred embodiment of the present invention, portions of original content within a page, or all of the original content within a page, can be designated as protected.

A parser 410 parses a page and identifies original content that is designated as protected. Such identified original content is transferred to an encoder 420 that encrypts the original content into encrypted content. The encrypted content and the page are transferred to an editor 430 that replaces the identified original content with the encrypted content, within the page. Transmitter 210 then transmits the page with the encrypted content to client computer 220 over the Internet.

Receiver 230 within client computer 220 receives the page with the encrypted content and transfers it to renderer 250 for rendering the page into a graphics device 260. In a preferred embodiment of the present invention, renderer 250 identifies the encrypted content and transfers it to a decoder 440 that decodes the encrypted content prior to the content being passed to content output module 290. Content output module 290 converts the decrypted content to graphics output, which is written into graphics device 260. Finally, a portion of data in graphics device 260, or all of the data in graphics device 260, is displayed on display device 270 connected to client computer 220.

An important aspect of the present invention is that without the intervention of decoder 440, the page being rendered into graphics device 260 contains encrypted content. Any other application that captures data from the page will only capture the encrypted content, which typically appears as gibberish. Thus the original content designated as protected is not exposed to other applications.

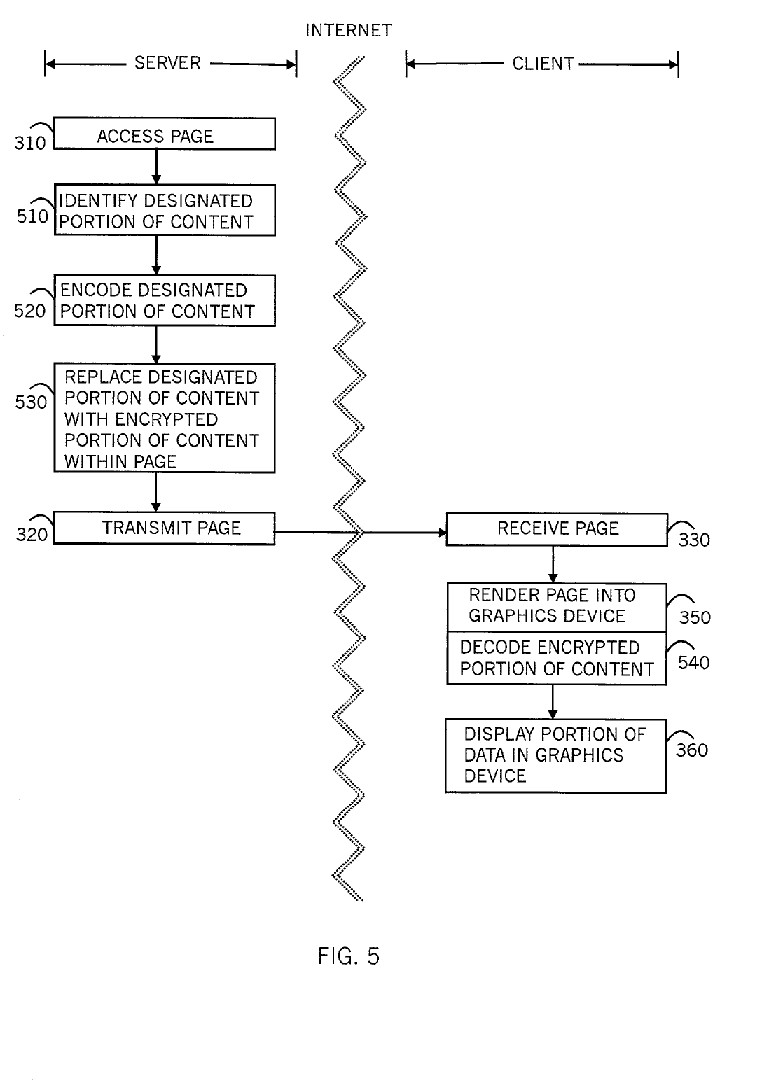

Reference is now made to FIG. 5, which is a simplified flow diagram of a method for protection of content within a page according to a preferred embodiment of the present invention. At step 310 a server computer, such as server computer 100 (FIG. 4) accesses a web page. A portion of original content within the web page, or all of the original content within the page, is designated as protected. At step 510 the server computer identifies the portion of original content designated as protected. At step 520 the server computer encodes the designated portion of original content into encrypted content. At step 530 the server computer replaces the designated portion of original content with the encrypted content, within the page. At step 320 the server computer transmits the page with the encrypted content to a client computer, such as client computer 220 (FIG. 4), over the Internet.

At step 330 the client computer receives the page with the encrypted portion of content. At step 350 the client computer renders the page with the encrypted portion of content into a graphics device. While rendering the page, at step 540 the client computer decodes the encrypted portions of content prior to the content being rendered into the graphics device. At step 360 the client computer displays a portion or all of the contents in the graphics device on a display device connected to the client computer.

Although a user of the present invention viewing content sees decrypted content, at every other level of the system except for a frame buffer within a video card, the content is encrypted. In distinction to the present invention, conventional encryption technologies, such as PGP, decrypt encrypted content to a temporary file, from which a user views protected content. The present invention, however, does not decrypt encrypted content at the application level—only at the display level.

Although the present invention is described in FIGS. 4 and 5 as embodied within a client server architecture, it is readily apparent to persons skilled in the art that it can alternately be embodied within a single computer. In this alternate embodiment, parser 410, encoder 420 and editor 430 reside within client computer 220. Similarly, steps 310, 510, 520 and 530 can be performed by the client computer. In this alternate embodiment, transmitter 210 and receiver 230 are unnecessary, and steps 320 and 330 are unnecessary. This alternate embodiment applies to situations wherein the pages containing designated text for protection already reside on client computer 220.

Additionally, the present invention can be embodied in separate computers, not necessarily within a client server environment, whereby one computer is used for creating a document with protected text, and another computer is used for viewing the document. The computer creating the document preferably includes parser 410, encoder 420 and editor 430, and the computer viewing the document preferably includes renderer 250, decoder 440 and graphics device 260. Similarly, steps 310, 510, 520 and 530 are preferably performed by the computer creating the document, and steps 350, 540 and 360 are preferably performed by the computer viewing the document.

Additionally, a page with encrypted content may already be stored within client computer 220, in which case the use of server computer 200 to encrypt and transmit the page is unnecessary.

The present invention may alternatively employ a filter, rather than server computer 200, in order to encrypt protected content. Such a filter can be embodied in the form of a COM object or a Java bean that can interface with enterprise applications such as Microsoft Exchange. Thus it may be appreciated that the present invention can be adapted to protect content within HTML and e-mail and, more generally, to protect enterprise data.

The formatting of text within a document page can be pre-determined based on formatting parameters and control characters pre-set by a user creating the document, or dynamically at the time of rendering based on dimensions of a display window. The former setup is typical for highly structured documents, such as Microsoft Word documents. When creating such documents, a user can pre-set font sizes, character, line and paragraph spacings, and left, right, top and bottom margins, and insert white space characters, indentation characters, and carriage return/line feed characters within text. In this scenario, the user creating the document has substantial control over the way text within the document is formatted.

The latter setup is typical for less structured documents, such as HTML web pages. As can be seen in a source listing for an HTML page, text within HTML is typically strung out as a long stream of characters, without carriage return/line feeds markings. A web browser typically dictates the format of text within an HTML page dynamically at the time of rendering, based on computer display settings, relative font sizes for different levels of headings and body text, and the layout of other objects within the HTML page such as images and hyper links. Thus, for example, the text within the HTML page illustrated in FIG. 1A is simply a single stream of characters, and its formatting in terms of lines is determined by a web browser.

Typically dynamic formatting is performed by measuring widths of words or elements on a page. From this information, a layout of the page can be determined. With text, for example, the layout is determined based on how many words can be fit within a line before starting a new line. Once a layout has been determined, text and other elements are rendered to a screen in correct locations.

Many applications use functions similar to the Windows Device Context API function

CSize GetTextExtent(LPCTSTR lpszstring, int nCount) const;

A string of characters is passed to such a function. A device content already knows the font metrics, including font type and size, and these are used to calculate the width of the string, in measurement units appropriate to the device context.

For example, the following program instructions illustrate a typical device context setup.

DC=newDC

DC→SetFont(Ariel Bold)

DC→SetSize(12)

DC→TextOut(“Hello”)

The first line sets up a new device context. The second line sets the font type to Ariel Bold. The third line sets the font size to 12 pt. The fourth line outputs the text string “Hello.” At this last stage of outputting text, the font type and font size for the device context have already been set.

Since the present invention operates by replacing protected original text with encrypted text, it is important to address the issue that the characters and words of the encrypted text may not have the same sizes and widths as those of the original text. For applications with dynamic text layout, formatter 240 (FIG. 2) may derive an improper page layout, based on the encrypted text rather than on the original text. For example, formatter 240 may allocate too many lines for text or too few lines for text. When decoder 440 decrypts the encrypted text and renders it into graphics device 260, the decrypted text may not fill up the lines allocated therefor, in the case of too many lines, or may overlap other objects such as images, in the case of too few lines.

One approach to this issue is to ensure that the characters and words of the encrypted text have the same sizes and lengths as those of the original text, by using character-by-character encryption. However, character-by-character encryption has a drawback of being too simplistic an encoding—one that can easily be cracked.

In a preferred embodiment, the present invention operates by employing more complex encryption than character-by-character encryption, and “fooling” formatter 240 into believing that the encrypted text does indeed have the same character and word sizes as the original text, when in fact it does not.

As mentioned hereinabove, formatter 240 typically determines a page layout based on widths of words in text, and it typically identifies such widths by invoking functions such as Microsoft Windows' GetTextExtent( ). In a preferred embodiment, the present invention patches such functions so as to return lengths of words in the original text, instead of lengths of words in the encrypted text within the page. Specifically, the patched portion of GetTextExtent( ) decrypts the input string and passes the decrypted string to the conventional GetTextExtent( ) function. Formatter 240 then determines a layout based upon the decrypted text, rather than upon the encrypted text.

Typically formatters do not simply call GetTextExtent( ) with individual words in order to determine how many words fill up a line. Rather, they call GetTextExtent( ) with larger units, such as a complete sentence or even a complete paragraph. Based on the size returned by GetTextExtent( ), the formatter then iteratively sends a shorter string or longer string, depending on whether the previous string size was in excess or in deficiency of a full line, respectively. In any event, the present invention, by decrypting whatever string is input to GetTextExtent( ) ensures that the size returned by GetTextExtent( ) corresponds to decrypted text.

Typically, the steps involved in rendering a page having text and possibly other objects are:

1. Receive data.

2. Divide the data into individual granular elements, such as words.

3. Measure the size of each element.

4. Determine a layout, based on the sizes of the elements.

5. Render the page to a display device, based on the layout.

In a preferred embodiment, the present invention intervenes at steps 3 and 5, by decrypting encrypted data and replacing the encrypted data with the corresponding decrypted data.

Thus it may be appreciated that the present invention can employ complex encryption algorithms, based on words rather than individual characters, without resulting in improper text layouts. The present invention can employ encryption algorithms that encrypt each word, and that add leading and trailing characters to flag text as being encrypted. The present invention can also pad encrypted text so that identical words have distinct encrypted representations, thereby preventing users from thwarting the present invention by building up dictionaries of encrypted and matching decrypted words.

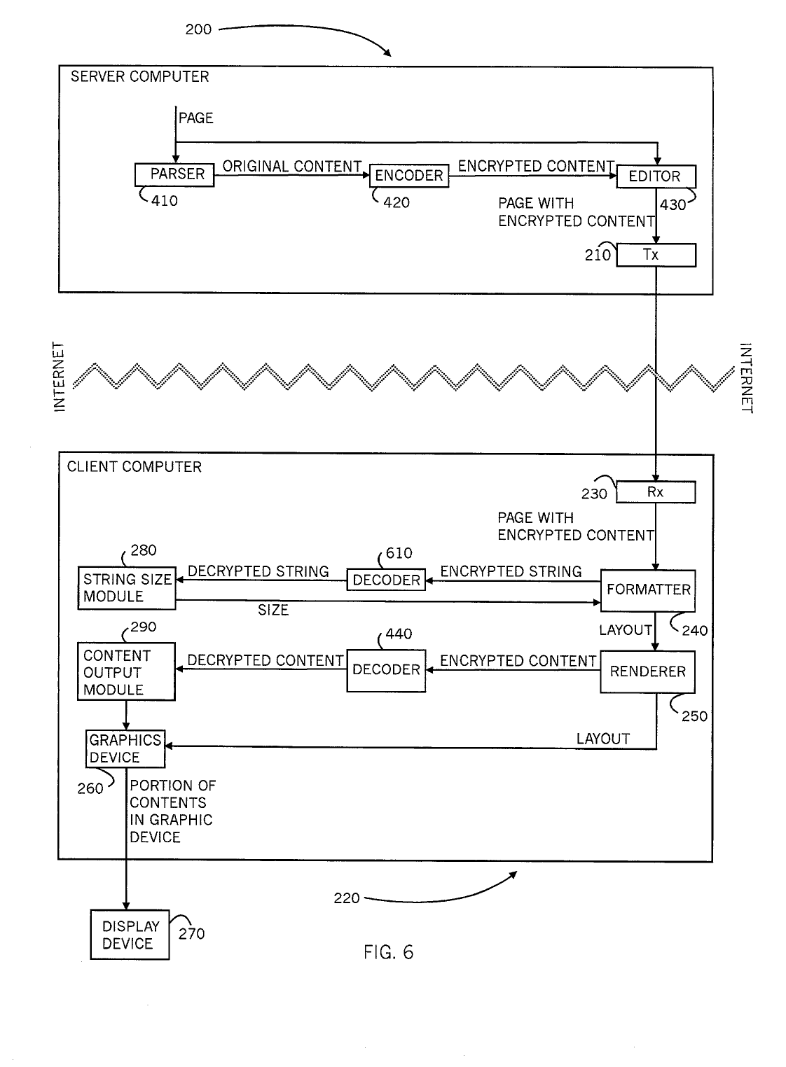

Reference is now made to FIG. 6, which is a simplified block diagram of a system for protection of content within a page including a formatting module, according to a preferred embodiment of the present invention. FIG. 6 includes the elements of FIG. 4, and additionally includes formatter 240, decoder 610 and string size module 280. Formatter 240 calls string module 280 to identify widths of various character strings, relative to the font types and font sizes of a device context, in order to determine a page layout. Specifically, formatter 240 uses character string width information to determine how many words to fit in lines of the page. Decoder 610 intercepts the character strings on their way to string size module 280, and replaces them with decrypted strings prior to string size module 280 determining the string widths. The intervention of decoder 610 ensures that the string widths provided to formatter 440 for determining a page layout correspond to string widths for decrypted strings, rather than for encrypted strings which typically have different word widths.

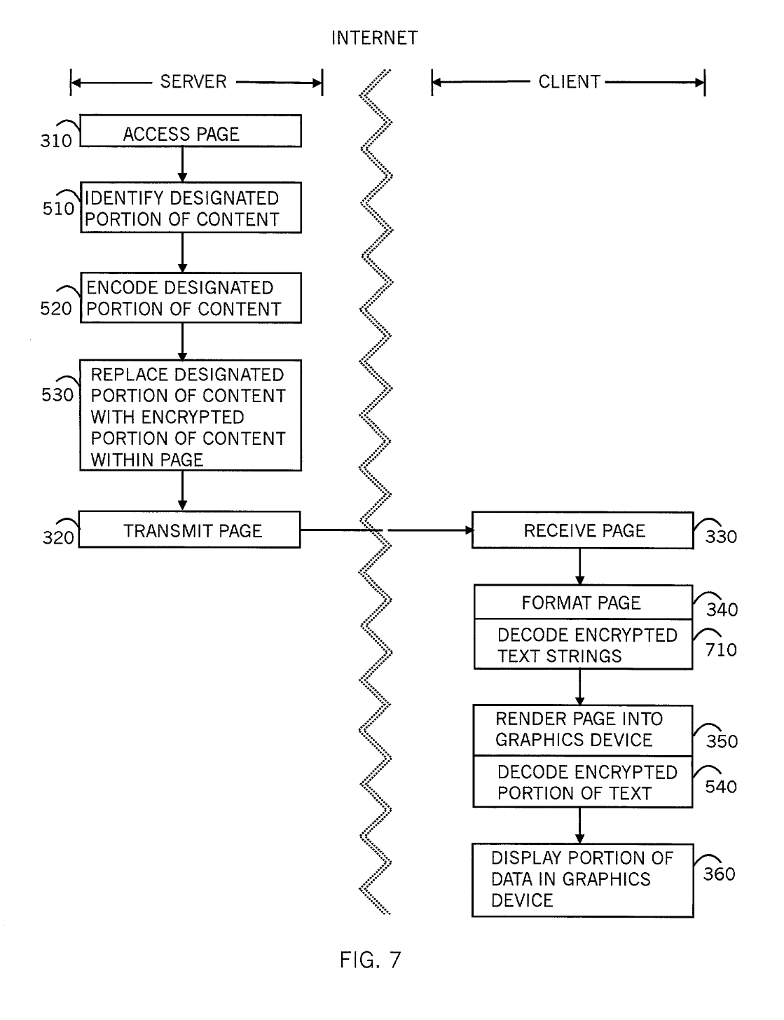

Reference is now made to FIG. 7, which is a simplified flow diagram of a method for protection of content within a page including a formatting step, according to a preferred embodiment of the present invention. FIG. 7 includes the steps of FIG. 5, and additionally include step 340 formatting the page, and step 710 decoding encrypted text strings.

Implementation Details

In a preferred embodiment of the present invention, decoding step 540 (FIG. 5) is performed within a patched operating system function that is used by renderer 250 (FIG. 2) to convert text to raster data within graphics device 260. Specifically, when rendering a page into a graphics device for display, text is converted into a bitmap image. In the Microsoft Windows operating system, for example, a function TextOut( ) is invoked to convert text to bitmap; and in the Macintosh operating system a similar function DrawText( ) is used.

The term “patching” as used throughout the present invention includes several techniques for intervening with a function call. These include:

1. Inserting additional instructions into the function itself.

2. Re-directing a call to the function with a call to a different function.

3. Changing an address of the function within a look-up table to an address of a different function.

Technique 1 above involves inserting program code within the code for the function. Technique 2 above involves re-directing a call to function f1( ) with a call to function f2( ). Typically, function f2( ) performs certain operations and then itself calls function f1( ). Alternatively, function f2( ) can include program code for f1( ) within itself. Technique 3 involves changing an address of function f1( ) to an address of function f2( ). Again, function f2( ) can either perform operations and then itself call function f1( ), or else include program code for function f1( ) within itself.

In several Microsoft Windows operating systems, when an application is executed, the system creates a look-up table in its process space, with addresses for each of the system functions called by the application. The present invention preferably identifies entries in the look-up table corresponding to functions that it patches, and replaces the addresses in the look-up table with addresses to other functions.

The present invention operates by patching system functions such as TextOut( ) and DrawText( ) so as to decode encrypted content prior to rasterization. In this way, the page itself never exists as a page with decrypted content on client computer 150, and, as such, the protected original content is never exposed. If a user views a source listing for a page with protected text, the protected text shows up as encrypted text, which typically appears as gibberish. Similarly, if an application captures the page at any stage, the page includes the encrypted text. It is only upon display that the protected original text appears.

Assignee's pending patent application U.S. Ser. No. 09/397,331 referenced hereinabove, describes protection of raster data displayed on a display device. Using the method and system described therein, graphical system functions such as BitBlt( ), StretchBlt( ), PlgBlt( ) and GetPixel( ) can be patched so that if an application performs a screen capture, the image actually captured is watermarked, or else is a substitute image altogether. Thus by combining the present invention with the invention described in U.S. Ser. No. 09/397,331, original text can be protected both while it is on screen and while it is off screen.

In a preferred embodiment, for reasons of security the present invention is selective as to which device contexts it renders decrypted data to. For example, the present invention may be configured so as to render decrypted data to screen device contexts but not to render decrypted data to memory or printer device contexts. The permitted device contexts are preferably stored in a “white list,” which the present invention accesses to determine whether or not to render decrypted data to a specific device context.

Additional Considerations

In reading the above description, persons skilled in the art will realize that there are many apparent variations that can be applied to the methods and systems described. Although the present invention has been described with reference to copy protection of text, it applies to other forms of data as well, including audio data, image data and video data. The present invention provides a methodology to protect content of data that is rendered and formatted using patchable system calls.

For example, the present invention can be applied to image data by encrypting the data prior to its being saved or converted into a graphics format. On the receiving end, such data is rendered into a bitmap and then displayed by employing systems calls such as BitBlt( ) and StretchBlt( ). In a preferred embodiment, at the point at which the encrypted image data is passed to BitBlt( ) or StretchBlt( ) for display, the present invention decrypts the image data by patching the BitBlt( ) and StretchBlt( ) system functions.

Similarly, for audio data, the present invention preferably replaces such data with encrypted data, and only decodes the encrypted data when it is being rendered to a device for playing on an audio sound card.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A method for protecting content within a page displayed by a computer, comprising:
identifying a designated portion of original content contained within a page, to be protected;
encrypting the designated portion of original content to form a portion of encrypted content;
replacing the designated portion of original content within the page with the portion of encrypted content;
rendering the page into a graphics device, comprising decrypting the portion of encrypted content; and
displaying at least a portion of data from the graphics device.

2. The method of claim 1 wherein the page is a web page.

3. The method of claim 2 wherein the web page is an HTML page.

4. The method of claim 2 wherein the web page is an XML page.

5. The method of claim 1 wherein the page is part of a document produced by a software application.

6. The method of claim 1 wherein the graphics device is a memory device.

7. The method of claim 1 wherein the graphics device is a screen device.

8. The method of claim 1 wherein the graphics device is a graphics port.

9. The method of claim 1 wherein the content is text content and said encrypting is based on encoding of characters.

10. The method of claim 1 wherein the content is text content and said encrypting is based on encoding of words.

11. The method of claim 1 wherein the content is text content and said encrypting comprises adding leading and trailing characters to flag encrypted text.

12. The method of claim 1 wherein the content is text content and said encrypting comprises padding encrypted text so that identical words have distinct encrypted representations.

13. The method of claim 1 wherein said rendering comprises converting content into graphics output.

14. The method of claim 13 wherein the graphics output is raster output.

15. The method of claim 1 wherein said identifying, said encrypting and said replacing are performed by a server computer, and wherein said rendering and said displaying are performed by a client computer connected to the server computer over a network.

16. The method of claim 1 wherein said decrypting the portion of encrypted content occurs within a patched operating system function for outputting content.

17. The method of claim 16 wherein the content is text content and the operating system function is a Microsoft Windows TextOut function.

18. The method of claim 16 wherein the content is text content and the operating system function is a Macintosh DrawText function.

19. The method of claim 1 further comprising formatting the page to determine a page layout.

20. The method of claim 19 wherein the portion of encrypted content has substantially the same layout within the page as the designated portion of original content.

21. The method of claim 19 wherein said formatting comprises decrypting encrypted content, to ensure that the page layout corresponds to a layout for a page containing the designated portion of original content.

22. The method of claim 19 wherein the content is text content and said formatting comprises calculating widths of character strings.

23. The method of claim 22 wherein said formatting comprises decrypting encrypted text strings, to ensure that the page layout corresponds to a layout for a page containing the designated portion of original content.

24. The method of claim 23 wherein said decrypting encrypted text strings occurs within a patched operating system function for determining widths of character strings.

25. The method of claim 24 wherein the operating system function is a Microsoft Windows GetTextExtent function.

26. A system for protecting content within a page displayed by a computer, comprising:
a parser identifying a designated portion of original content contained within a page, to be protected;
an encoder encrypting the designated portion of original content to form a portion of encrypted content;
an editor replacing the designated portion of original content with the portion of encrypted content, within the page;
a graphics device;
a page renderer rendering the page into said graphics device, comprising a content decoder decrypting the portion of encrypted content; and
a display device displaying at least a portion of data from said graphics device.

27. The system of claim 26 wherein the page is a web page.

28. The system of claim 27 wherein the web page is an HTML page.

29. The system of claim 27 wherein the web page is an XML page.

30. The system of claim 26 wherein the page is part of a document produced by a software application.

31. The system of claim 26 wherein said graphics device is a memory device.

32. The system of claim 26 wherein said graphics device is a screen device.

33. The system of claim 26 wherein said graphics device is a graphics port.

34. The system of claim 26 wherein the content is text content and said encoder performs encoding of characters.

35. The system of claim 26 wherein the content is text content and said encoder performs encoding of words.

36. The system of claim 26 wherein the content is text content and said encoder adds leading and trailing characters to flag encrypted text.

37. The system of claim 26 wherein the content is text content and said encoder pads encrypted text so that identical words have distinct encrypted representations.

38. The system of claim 26 wherein said page renderer comprises an output processor converting content into graphics output.

39. The system of claim 38 wherein the graphics output is raster output.

40. The system of claim 26 wherein said parser, said encoder and said editor reside on a server computer, wherein said graphics device and said page renderer reside on a client computer, and wherein said display device is connected to the client computer, the system further comprising network connectors connecting the client computer to the server computer.

41. The system of claim 26 wherein said content decoder operates within a patched operating system function for outputting content.

42. The system of claim 41 wherein the content is text content and the operating system function is a Microsoft Windows TextOut function.

43. The system of claim 41 wherein the content is text content and the operating system function is a Macintosh DrawText function.

44. The system of claim 26 further comprising a page formatter formatting the page to determine a page layout.

45. The system of claim 44 wherein the portion of encrypted content has substantially the same layout within the page as the designated portion of original content.

46. The system of claim 44 wherein said page formatter comprises a decoder, to ensure that the page layout corresponds to a layout for a page containing the designated portion of original content.

47. The system of claim 44 wherein the content is text content and s aid page formatter comprises a string analyzer calculating widths of character strings.

48. The system of claim 47 wherein said page formatter comprises a string decoder decrypting encrypted text strings, to ensure that the page layout corresponds to a layout for a page containing the designated portion of original content.

49. The system of claim 48 wherein said string decoder operates within a patched operating system function for determining widths of character strings.

50. The system of claim 49 wherein the operating system function is a Microsoft Windows GetTextExtent function.

51. A method for protecting content contained within a page displayed by a computer, comprising:
accessing a page containing a portion of encrypted content;
rendering the page into a graphics device, comprising decrypting the portion of encrypted content; and
displaying at least a portion of data from the graphics device.

52. The method of claim 51 wherein the page is a web page.

53. The method of claim 52 wherein the web page is an HTML page.

54. The method of claim 52 wherein the web page is an XML page.

55. The method of claim 51 wherein the page is part of a document produced by a software application.

56. The method of claim 51 wherein the graphics device is a memory device.

57. The method of claim 51 wherein the graphics device is a screen device.

58. The method of claim 51 wherein the graphics device is a graphics port.

59. The method of claim 51 wherein said rendering comprises converting content into graphics output.

60. The method of claim 59 wherein the graphics output is raster output.

61. The method of claim 51 wherein said decrypting the portion of encrypted content occurs within a patched operating system function for outputting content.

62. The method of claim 61 wherein the content is text content and the operating system function is a Microsoft Windows TextOut function.

63. The method of claim 61 wherein the content is text content and the operating system function is a Macintosh DrawText function.

64. The method of claim 51 further comprising formatting the page to determine a page layout.

65. The method of claim 64 wherein the portion of encrypted content has substantially the same layout within the page as the portion of decrypted content.

66. The method of claim 64 wherein said formatting comprises decrypting encrypted content, to ensure that the page layout corresponds to a layout for a page containing the designated portion of original content.

67. The method of claim 64 wherein the content is text content and said formatting comprises calculating widths of character strings.

68. The method of claim 67 wherein said formatting comprises decrypting encrypted text strings, to ensure that the page layout corresponds to a layout for a page containing the portion of decrypted content.

69. The method of claim 68 wherein said decrypting encrypted text strings occurs within a patched operating system function for determining widths of character strings.

70. The method of claim 67 wherein the operating system function is a Microsoft Windows GetTextExtent function.

71. The method of claim 51 further comprising receiving the page having a portion of encrypted content from a server computer.

72. A system for protecting content contained within a page displayed by a computer, comprising:
computer hardware storing a page containing a portion of encrypted content;
a graphics device;
a page renderer rendering the page into said graphics device, comprising a content decoder decrypting the portion of encrypted content; and
a display device displaying at least a portion of data from said graphics device.

73. The system of claim 72 wherein the page is a web page.

74. The system of claim 73 wherein the web page is an HTML page.

75. The system of claim 73 wherein the web page is an XML page.

76. The system of claim 72 wherein the page is part of a document produced by a software application.

77. The system of claim 72 wherein said graphics device is a memory device.

78. The system of claim 72 wherein said graphics device is a screen device.

79. The system of claim 72 wherein said graphics device is a graphics port.

80. The system of claim 72 wherein said page renderer comprises an output processor converting content into graphics output.

81. The system of claim 80 wherein the graphics output is raster output.

82. The system of claim 72 wherein said content decoder operates within a patched operating system function for outputting content.

83. The system of claim 82 wherein the content is text content and the operating system function is a Microsoft Windows TextOut function.

84. The system of claim 82 wherein the content is text content and the operating system function is a Macintosh DrawText function.

85. The system of claim 72 further comprising a page formatter formatting the page to determine a page layout.

86. The system of claim 85 wherein the portion of encrypted content has substantially the same layout within the page as the portion of decrypted content.

87. The system of claim 85 wherein said page formatter comprises a decoder, to ensure that the page layout corresponds to a layout for a page containing the designated portion of original content.

88. The system of claim 85 wherein the content is text content and said page formatter comprises a string analyzer calculating widths of character strings.

89. The system of claim 88 wherein said page formatter comprises a string decoder decrypting encrypted text strings, to ensure that the page layout corresponds to a layout for a page containing the portion of decrypted content.

90. The system of claim 89 wherein said string decoder operates within a patched operating system function for determining widths of character strings.

91. The system of claim 90 wherein the operating system function is a Microsoft Windows GetTextExtent function.

92. The system of claim 72 further comprising:
a network connector; and
a receiver receiving the page having a portion of encrypted content from a server computer via said network connector.

93. A method for protecting content contained within a page displayed by a computer, comprising:
identifying a designated portion of original content within a page, to be protected;
encrypting the designated portion of original content to form a portion of encrypted content; and
replacing the designated portion of original content within the page with the portion of encrypted content.

94. The method of claim 93 wherein the page is a web page.

95. The method of claim 94 wherein the web page is an HTML page.

96. The method of claim 94 wherein the web page is an XML page.

97. The method of claim 93 wherein the page is part of a document produced by a software application.

98. The method of claim 93 wherein the content is text content and said encrypting is based on encoding of characters.

99. The method of claim 93 wherein the content is text content and said encrypting is based on encoding of words.

100. The method of claim 93 wherein the content is text content and said encrypting comprises adding leading and trailing characters to flag encrypted text.

101. The method of claim 93 wherein the content is text content and said encrypting comprises padding encrypted text so that identical words have distinct encrypted representations.

102. The method of claim 93 wherein the portion of encrypted content has substantially the same layout within the page as the designated portion of original content.

103. The method of claim 93 further comprising transmitting the page with the portion of encrypted content to a client computer.

104. A system for protecting content contained within a page displayed by a computer, comprising:
a parser identifying a designated portion of original content within a page, to be protected;
an encoder encrypting the designated portion of original content to form a portion of encrypted content; and
an editor replacing the designated portion of content with the portion of encrypted content, within the page.

105. The system of claim 104 wherein the page is a web page.

106. The system of claim 105 wherein the web page is an HTML page.

107. The system of claim 105 wherein the web page is an XML page.

108. The system of claim 104 wherein the page is part of a document produced by a software application.

109. The system of claim 104 wherein the content is text content and said encoder performs encoding of characters.

110. The system of claim 104 wherein the content is text content and said encoder performs encoding of words.

111. The system of claim 104 wherein the content is text content and said encoder adds leading and trailing characters to flag encrypted text.

112. The system of claim 104 wherein the content is text content and said encoder pads encrypted text so that identical words have distinct encrypted representations.

113. The system of claim 104 wherein the portion of encrypted content has substantially the same layout within the page as the designated portion of original content.

114. The system of claim 104 further comprising:
a network connector; and
a transmitter transmitting the page with the portion of encrypted content to a client computer via said network connector.

115. A method for protecting text within a page displayed by a computer, comprising:
formatting a page containing a first portion of text to determine a page layout; and
rendering the page according to the page layout into a graphics device, comprising:
replacing the first portion of text with a second portion of text;
converting the second portion of text to a graphics output; and
writing the graphics output into the graphics device.

116. The method of claim 115 wherein the first portion of text has the same word widths as does the second portion of text.

117. The method of claim 115 wherein the graphics output is raster output.

118. The method of claim 115 wherein said replacing the first portion of text with a second portion of text occurs within a patched operating system function for converting text into graphics output.

119. The method of claim 118 wherein the operating system function is a Microsoft Windows TextOut function.

120. The method of claim 118 wherein the operating system function is a Macintosh DrawText function.

121. The method of claim 115 wherein said formatting comprises:
replacing first text strings with second text strings; and
calculating widths of the second text strings based on selected font types and font sizes.

122. The method of claim 121 wherein said replacing first text strings with second text strings occurs within a patched operating system function for determining widths of character strings.

123. The method of claim 122 wherein the operating system function is a Microsoft Windows GetTextExtent function.

124. A system for protecting text within a page displayed by a computer, comprising:
a page formatter formatting a page containing a first portion of text to determine a page layout; and
a page renderer rendering the page according to the page layout into a graphics device, comprising:
a text processor replacing the first portion of text with a second portion of text; and
a text convertor converting the second portion of text to a graphics output and writing the graphics output into the graphics device.

125. The system of claim 124 wherein the first portion of text has the same word widths as does the second portion of text.

126. The method of claim 124 wherein the graphics output is raster output.

127. The system of claim 124 wherein said text processor operates within a patched operating system function for converting text into graphics output.

128. The system of claim 127 wherein the operating system function is a Microsoft Windows TextOut function.

129. The system of claim 127 wherein the operating system function is a Macintosh DrawText function.

130. The system of claim 124 wherein said formatter comprises:
a string processor replacing first text strings with second text strings; and
a string analyzer calculating widths of the second text strings based on selected font types and font sizes.

131. The system of claim 130 wherein said string processor operates within a patched operating system function for determining widths of character strings.

132. The system of claim 131 wherein the operating system function is a Microsoft Windows GetTextExtent function.

133. A method for protecting content within a page displayed by a computer, comprising:
encrypting a designated portion of original content contained within a page to form a portion of encrypted content;
replacing the designated portion of original content within the page with the portion of encrypted content; and
decrypting the portion of encrypted content when rendering the page into a graphics device.

134. The method of claim 133 further comprising decrypting an encrypted string when formatting the page to determine a page layout.

135. A system for protecting content within a page displayed by a computer, comprising:
an encoder encrypting a designated portion of original content contained within a page to form a portion of encrypted content;
an editor replacing the designated portion of original content with the portion of encrypted content, within the page; and
a content decoder decrypting the portion of encrypted content when rendering the page into a graphics device.

136. The system of claim 135 further comprising a string decoder decrypting an encrypted string when formatting the page to determine a page layout.

137. A method for protecting content contained within a page displayed by a computer, comprising:
accessing a page containing a portion of encrypted content; and
decrypting the portion of encrypted content when rendering the page into a graphics device.

138. The method of claim 137 further comprising decrypting an encrypted string when formatting the page to determine a page layout.

139. A system for protecting content contained within a page displayed by a computer, comprising:
computer hardware storing a page containing a portion of encrypted content; and
a content decoder decrypting the portion of encrypted content when rendering the page into a graphics device.

140. The system of claim 139 further comprising a string decoder decrypting an encrypted string when formatting the page to determine a page layout.

141. A method for protecting text within a page displayed by a computer, comprising:
replacing first text strings with second text strings when formatting a page to determine a page layout; and
replacing a first portion of text with a second portion of text when rendering the page according to the page layout into a graphics device.

142. A system for protecting text within a page displayed by a computer, comprising:
a string processor replacing first text strings with second text strings when formatting a page to determine a page layout; and
a text processor replacing a first portion of text with a second portion of text when rendering the page according to the page layout into a graphics device.
